(19) United States
(12) Patent Application Publication
(10) Pub. No.: US 2011/0030316 A1
(43) Pub. Date: Feb. 10, 2011

(54) GRIPPING DEVICE FOR PICKING UP CONTAINERS AND CLOSURES AND FOR CLOSING THE CONTAINERS

(76) Inventors: Klaus Blumenstock, Satteldorf (DE); Michael Simon, Crailsheim (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/736,593

(22) PCT Filed: Apr. 1, 2009
(86) PCT No.: PCT/EP2009/053852

§ 371 Date: Oct. 21, 2010

(30) Foreign Application Priority Data
Apr. 21, 2008 (DE) 10 2008 001 288.2

(51) Int. Cl. B67B 1/00

(52) U.S. Cl. 53/319

(57) ABSTRACT

The invention relates to a gripping device which has a container picking up device and a closure pick up device for picking up and closing containers. The container pick up device is designed to pick up the container, and the closure pick up device is designed to pick up a closure. The closure pick up device is connected to the container pick up device by means of a connecting element which allows a relative movement between the container pick up device and the closure pick up device to take place in order for the container to be closed with the closure.

### PRIOR ART

The invention relates to a gripping device for receiving containers and closures and for closing the containers, which makes it possible to design a production sequence flexibly.

From the prior art, packaging machines with rotating star wheels are known. By means of these star wheels, bottle-shaped containers are separated and conveyed. The closure is done by so-called pick-and-place units, which are disposed above the containers or star wheels. The pick-and-place units close the containers, for instance with stoppers, by means of revolving, horizontally or vertically located stopper wheels, or with revolving, cam-controlled stopper placement assemblies. This type of closing entails considerable effort and expense for format parts, since the construction of these star wheels and placement assemblies is dictated by the containers and closures. Moreover, the apparatuses of the prior art do not allow flexible design of the work sequence of filling and closing operations.

### ADVANTAGES OF THE INVENTION

The gripping device of the invention having the characteristics of claim 1 has the advantage over the prior art that it can be produced economically because of its simple construction. This makes flexible, economical production of the gripping device possible for various containers and closures. Moreover, the gripping device is designed as a module and thus forms a closed-off modular component of a production chain. This modularity permits a flexible variation of the gripping device, without having to change the production chain upstream or downstream of the gripping device. In addition, the design of the gripping device as a module makes it possible for the entire gripping device to be moved within, the production chain during the closing operation. As a result, not only is production time saved, but one production step, which is provided only for conveying the containers, is integrated with the closing operation. This is attained according to the invention in that the gripping device includes a container pickup device and a closure pickup device. According to the invention, it is provided that the container pickup device can securely hold a filled container or bottle. The closure pickup device is intended for holding the closure. A connection element according to the invention on the one hand integrates the closure pickup device with the container pickup device and on the other enables a relative motion between the container pickup device and the closure pickup device. This relative motion serves to place the closure on the container. The construction according to the invention enables a gripping device to pick up a container, for instance from a filling station. Simultaneously with the gripping, or before or after the gripping of the container, a furnished closure is picked up by the closure pickup device. According to the invention, after and/or during the picking up operations, the gripping device moves to a position in the production chain in which the closed containers are to be set down. In other words, the gripping device conveys the containers within the production chain. During this conveying operation, the gripping device executes the relative motion between the container pickup device and the closure pickup device and closes the container with the closure. Thus the container is conveyed and closed simultaneously.

The dependent claims recite preferred refinements of the invention.

Preferably, the connection element includes a guide element. This guide element executes the relative motion between the container pickup device and the closure pickup device and thus makes the precise-fitting placement of the closure onto the container possible.

The embodiment of the guide element as a linear guide element is also preferred, for placing the closures linearly on the container opening. As a result, tilting of a stopper during its introduction into the container opening, for instance, is averted. Preferably, the linear guide element includes at least one rod, and the relative motion is guided by this rod. For the form of the rod, either a hollow or a solid cylinder and an angular profile are conceivable.

To pick up a closure while the gripping device is in constant motion, the closure pickup device advantageous includes a closure towaway device. As a result, the gripping device can remove a furnished closure while the gripping device is moving in the production chain, and thus without a loss of time.

In an especially preferred embodiment, the closure towaway device includes a surface with an integrated pocket. The form and dimensions of the pocket correspond to the external dimensions of the closure. By means of a linear or curved opening in the pocket, the gripping device, while it is in motion, can pick up a closure and put it in the pocket.

Also preferably, intake openings are embodied on the container pickup device and/or the closure pickup device. By subjecting these intake openings to underpressure, a secure hold of the container and closure in the gripping device is ensured. Moreover, by withdrawing the underpressure, or by subjecting the intake openings to overpressure, two things can be achieved: First, the closure can be set on the container, and second, the container can be let go from the container pickup device at a certain time and thus at a certain position.

It is also provided according to the invention that the intake openings of the container pickup device and the closure pickup device each be supplied independently with underpressure. As a result, the underpressure at one opening is independent of a possible pressure increase at the other opening. For instance, if because of a malfunction the closure pickup device fails to pick up a closure, or if the closure is let go from the device, the pressure rises at the intake opening of the closure pickup device. Because of the separate underpressure supply, according to the invention, for the container pickup device, the underpressure at the intake opening of the container pickup device remains constant, and the container is not let go from the gripping device. Securing of the container in this way by means of the separate underpressure supply is especially advantageous if the contents of the container, if the are spilled, could damage the surrounding machines or could harm people.

Lowering the closure pickup device for placing the closure onto the container is also advantageous. As a result, the container pickup device is not moved relative to the gripping device, and an unnecessary acceleration of the contents of the container is avoided. This for instance prevents liquid contents from sloshing over. The lowering is preferably done pneumatically. A use of the above-described underpressure is conceivable for this. However, the drive of the relative motion is not limited to pneumatic means, and a mechanical or hydraulic drive is equally conceivable.

It is also provided according to the invention that the gripping device can pick up at least two containers and accordingly also at least two closures. As a result, the gripping device can be adapted to the pacing of the production chain, and the effectiveness of the production can be optimized.

Also preferably, a recess in the container pickup device is formed to correspond to the container, which ensures a form-locking pickup of the container. This form lock can either improve the hold of the container in combination with the intake opening, or it can replace the intake opening.

The use of a stopper as the closure is also preferred. Then an economical rubber stopper, for instance, can be pressed into the container by the gripping device of the invention.

According to the invention, a manipulator unit for picking up containers and closures and for closing the containers is also provided. This manipulator unit includes at least one gripping device according to the invention. Thus the manipulator unit can move the gripping device within the production chain from the pickup positions for containers and closures to the deposition position for closed containers. In addition, the unit can include the underpressure sources for picking up the containers and closures by suction and the pressure source for the pneumatically driven closing operation. As an alternative to this, it is provided that the manipulator unit also conducts a pressure and underpressure supply from an external source to the gripping device. The use of a freely programmable robot or robot arm as the manipulator unit is especially advantageous. The robot makes a flexible design of the course of motion of the gripping device within a production chain possible.

It is also provided according to the invention that the manipulator unit be driven inside an insulator, the insulator being disposed like a hood element over the gripping device. Thus closing the containers in an inert gas or in a vacuum is also possible.

The use of the gripping device and the manipulator unit in the pharmaceutical industry is also preferred. Especially in the range of small- and medium-sized batches, the gripping device of the invention and the manipulator unit of the invention afford a novel possibility of flexible design of the production chain.

Alternatively to picking up the closure by means of a towing motion, it is also advantageous to make the pickup of the closure intermittent. That is, the gripping device stops, picks up a closure, and then moves onward.

### BRIEF DESCRIPTION OF THE DRAWINGS

Below, a preferred exemplary embodiment of the invention is described, in conjunction with the accompanying drawings. In the drawings:

FIG. 1 is a perspective view of a gripping device in an exemplary embodiment of the invention;

FIG. 2 is a side view of the gripping device in the exemplary embodiment of the invention; and

FIG. 3 is a schematic illustration of the top view on a pharmaceutical system in accordance with the exemplary embodiment of the invention.

### PREFERRED EMBODIMENT OF THE INVENTION

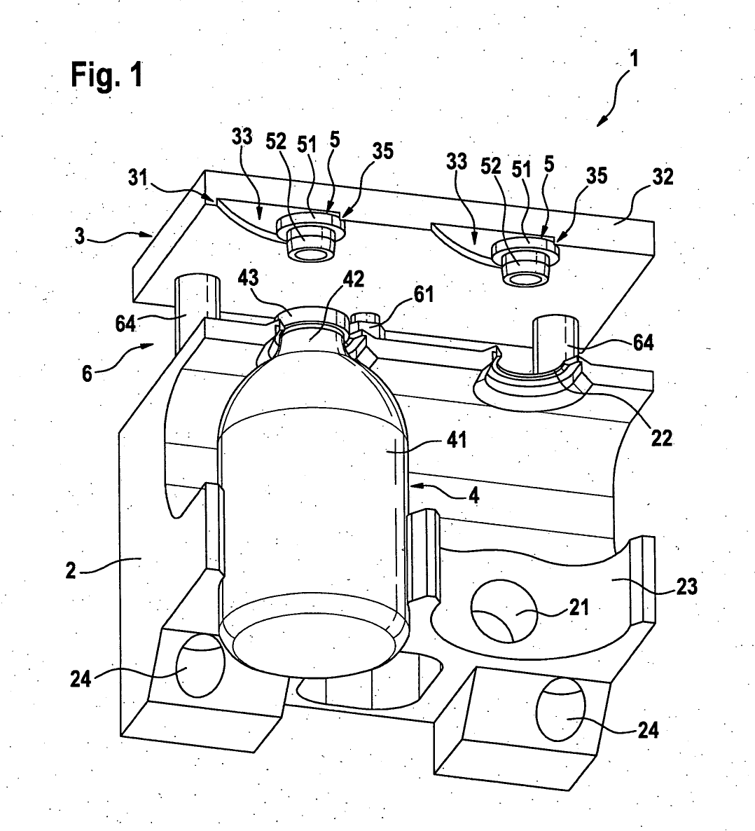

Below, in conjunction with FIGS. 1 through 3, a gripping device 1 in a preferred exemplary embodiment of the invention will be described in detail. The gripping device 1 of the exemplary embodiment is used with a manipulator unit 81 within a pharmaceutical system 8.

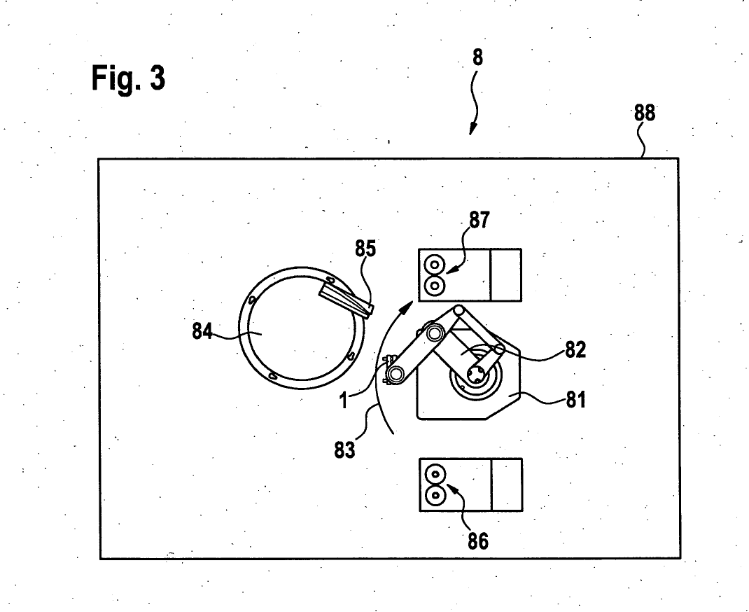

As can be seen from FIG. 1, the gripping device 1 includes a container pickup device 2, a closure pickup device 3, and connection elements 6. As will be described in conjunction with the pharmaceutical system 8 in FIG. 3, this gripping device 1 can pick up and transport two containers 4 and two closures 5. While they are being transported, the two containers 4 are closed with the closures 5. It should be noted here that depending on the required yield of the pharmaceutical system 8, the gripping device 1 of the invention can also be embodied for only one or for more than two containers 4. Moreover, the invention is not limited to the use of round, bottle-shaped containers 4. The use of angular bottles, cups, or containers is contemplated according to the invention as well.

In FIG. 1, for sake of simpler illustration, the container 4 on the right is not shown. Its associated closure 5, however, is shown.

What is shown in FIG. 1 is the bottle-shaped container 4 on the left, which includes a container body 41, a container neck 42, and a container collar 43. The container body 41 tapers toward the container neck 42, and the container neck 42 widens toward the container collar 43, which surrounds an opening of the container 4. Two stoppers 5, which are embodied as rubber stoppers 5, are also shown. Each of these rubber stoppers includes a cylindrical stopper collar 51 and a taper 52, which is dimensioned to suit the opening of the container 4.

The rubber stoppers 5 are especially suitable for secure airtight closure of containers 4 that are filled with pharmaceutical substances. However, the embodiment of the closures 5 as rubber stoppers 5 is merely an example. It is also provided according to the invention that the closures 5 be embodied as caps, twist closures, or stoppers of any material.

By means of a first form-locking contour 22 and a second form-locking contour 23, the container pickup device 2 holds the bottle-shaped container 4 in two different regions of the container 4. In doing so, the curved second form-locking contour 23 grasps the cylindrical container body 41. To ensure a secure hold, somewhat more than half the circumference of the container body 41 is grasped by the second form-locking contour 23. The first curved form-locking contour 22 moreover grasps the container neck 42 directly below the container collar 43. Thus the first form-locking contour 22 forms two form-locking retainers for the container 4. First, the container collar 43 rests on the container pickup device 2, preventing the container 4 from sliding downward. Second, the first form-locking contour 22 grips the container neck 42 over somewhat more than half its circumference. Preferably, the first form-locking contour 22 thus clamps the container 4 in place. According to the invention, it may also be contemplated to embody only one of the two form-locking contours 22, 23. An adaptation of the form-locking contours 22, 23 to container shapes that deviate from the shape of the container 4 shown is also contemplated according to the invention.

The closure pickup device 3 is embodied in the form of a plate 32. This plate 32 includes two closure towaway devices 31, each in the form of a milled-in, curved opening 33 and a pocket 35. Both of these curved openings 33 discharge into a respective pocket 35. The towing function of the closure towaway device 31 will be described in conjunction with FIG. 3. In FIG. 1, it can be seen how the rubber stopper 5 is held in form-locking fashion at the level of the stopper collar 51 by the pockets 35.

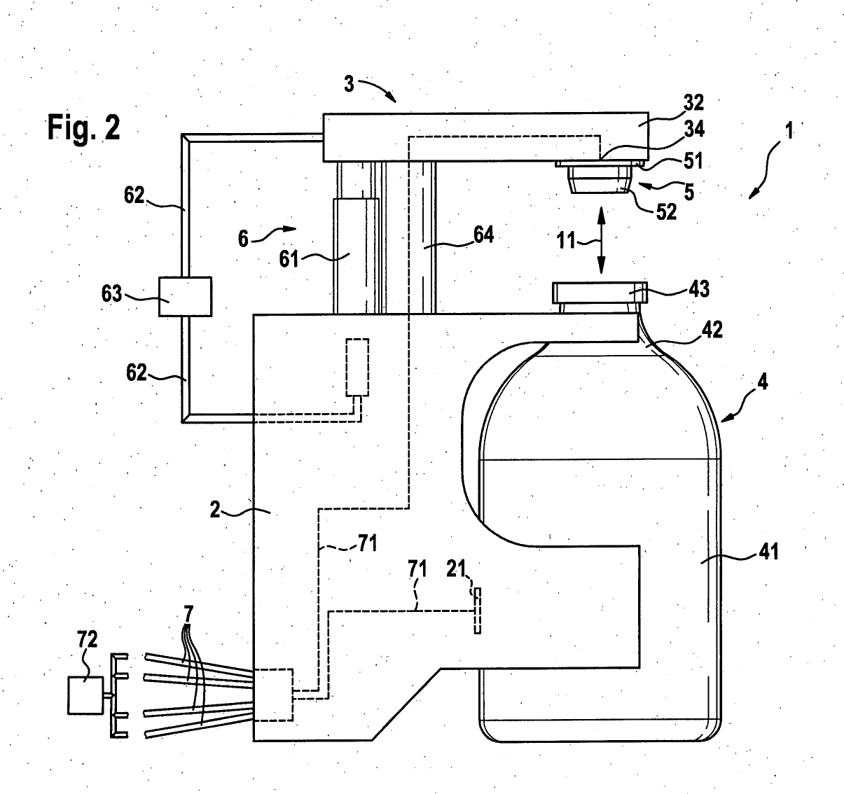

The connection element 6, which connects the container pickup device 2 with the closure pickup device 3, in this exemplary embodiment includes two linear guide elements 64 and one pneumatic cylinder 61. The pneumatic cylinder 61 will be described in conjunction with the comments on FIG. 2. The two linear guide elements 64 are embodied as cylindrical rods, which are solidly connected to the plate 32. For pressing the rubber stoppers 5 into the openings of the containers 4, a relative motion 11 is required between the container pickup device 2 and the closure pickup device 3. In the exemplary embodiment, this relative motion 11 is executed by lowering the plate 32 in the direction of the container pickup device 2. In order to press the rubber stoppers 5 into the containers 4 in a rectilinear motion, the two linear guide elements 64 are guided with a precise fit in two through bores 24. These through bores 24 each form one opening on the lower end of the container pickup device 2. It is advantageous to lower the rubber stoppers 5 onto the containers 4 and not to move the contents of the containers 4 unnecessarily. However, it is also possible to raise the container pickup device 2 in order to execute the relative motion 11.

In addition to the form-locking fixation of the containers 4 and rubber stoppers 5, the gripping device 1 of the invention has four intake openings 21, 34. Thus there is one first intake opening 21 per container 4 in the container pickup device 2, and one second intake opening 34 per closure 5 in the closure pickup device. The two first intake openings 21 are embodied as bores in the second form-locking contour 23 and are thus located at the level of the container bodies 41. The two second intake openings 34 are each located in the pockets 35 above the stopper collars 51. By means of the intake openings 21, 34, the containers 4 and rubber stoppers 5, respectively, are fixed with underpressure on the gripping device 1. Alternatively to the integrated intake openings, the gripping device may also have a suction system, placed on top, for picking up the containers 4 and rubber stoppers 5 by suction. The supply of underpressure to the gripping device 1 will be described hereinafter in conjunction with FIG. 2.

It should be noted that the underpressure intake 21 and the form-locking clamping 22, 23 of the containers 4 can also be employed alternatively. For instance, it is possible for the containers 4 to be fixed on the container pickup device 2 either via only one of the form-locking contours 22, 23 or via only the underpressure intake 21. The same is true for the rubber stoppers 5. They too can be fixed on the closure pickup device 3 by form locking 35, underpressure 34, or a combination of the two possibilities.

FIG. 2, in a side view, shows the gripping device 1 of the invention with the container pickup device 2, the closure pickup device 3, the container 4, the rubber stopper 5, and the connection element 6, in accordance with the exemplary embodiment. On the left-hand side of the container 4, inside the container pickup device 2, is the first intake opening 21 of the left-hand container 4. The second intake opening 34 of the left-hand rubber stopper 5 is located inside the closure pickup device 3, or plate 32, above the stopper collar 51. Although FIG. 2 shows only the two intake openings 21, 34 of the left-hand container 4, nevertheless, as already described, the gripping device 1 has four intake openings 21, 34. Each of these four intake openings 21, 34 communicates with an external underpressure source 72 via a separate underpressure line 7. Inside the gripping device 1, each of the four underpressure lines 7 communicates with one of the four intake openings by means of the internal underpressure distributor 71. Since the underpressure lines 7 for the two second intake openings 34 of the closure pickup device 3 also discharge into the container pickup device 2, the internal underpressure distributor 71 has conduits in the linear guide element 64 for carrying the underpressure from the container pickup device 2 to the closure pickup device 3.

FIG. 2 also shows the pneumatic cylinder 61 for carrying out the relative motion 11. By means of this linear relative motion 11, the rubber stoppers 5 are pressed into the containers 4. The pneumatic cylinder 61 includes a hollow cylinder, which is fitted into a bore in the container pickup device 2. A piston of the pneumatic cylinder 61 is located in this hollow cylinder. The pneumatic cylinder 61 is embodied as double-acting and can thus both lower and raise the closure pickup device 3 by operation with compressed air. Because of the double-acting embodiment, the pneumatic cylinder 61 has two pneumatic lines 62, which connect it to an external pressure source 63. It should be noted here that for the pneumatic cylinder 61, only a single pneumatic line 62 is also sufficient. Thus the motion for raising the closure pickup device 3 could for instance be taken over by spring integrated with the pneumatic cylinder 61.

It should be noted that alternatively, instead of being supplied via the pressure source 63, the pneumatic cylinder 61 could be jointly supplied via the underpressure lines 7. Moreover, the pneumatic cylinder 61 can replace one of the two linear guide elements 64. In that case, the pneumatic cylinder 61 takes on not only the raising and lowering work but also, together with the remaining linear guide element 64, ensures the linear guidance of the closure pickup device 3. As alternative to the pneumatic drive of the relative motion 11, a hydraulic or mechanical drive is possible.

FIG. 3 shows a schematic illustration of the top view on the pharmaceutical system 8 in the exemplary embodiment of the invention. The pharmaceutical system 8 functions in a pharmaceutical production chain as a transporting and closure unit for the containers 4. In this pharmaceutical system 8, the gripping device 1 of the invention is operated on a robot arm 82 of the manipulator unit 81. The robot arm 82 moves the gripping device 1 from a furnishing position 86 through a towing position 85 to a deposition position 87. In the process, by means of the robot arm 82, the gripping device 1 completes a curved towing motion, as indicated in FIG. 3 by the arrow 83 (in the direction opposite the direction of the arrow). A sorting device 84 aligns the rubber stoppers 5 and furnishes two rubber stoppers 5 at a time in the towing position 85. The rubber stoppers 5 are aligned so that they stand vertically and that the stopper collar 51 is above the taper 52.

From the deposition position 87, the gripping device 1 moves (counter to the arrow 83), without containers 4 and without rubber stoppers 5, in the direction of the towing position 85. In the process, with the curved towing motion, the gripping device 1 moves past the towing position 85 in order to remove the rubber stoppers 5. During the towing operation, the gripping device 1 remains constantly in motion. In this operation, the pockets 35 of the closure towaway devices 31 are located precisely at the level of the stopper collars 51, and thus the rubber stoppers 5 slide along the curved openings 33 into the pockets 35. In the pockets 35, the rubber stoppers 5 are held at the second intake openings 34 by means of the underpressure. Next, the gripping device 1 moves to the furnishing position 86, where it picks up two containers 4, filled with a pharmaceutical substance. These containers 4 are held at the two first intake openings 21 both via the two form-locking contours 22, 23 and via the underpressure. Immediately after the pickup of the containers 4, the gripping device 1 executes the relative motion 11 and thus closes the containers 4. As soon as the rubber stoppers 5 are seated in the containers 4, the underpressure can be withdrawn from the second intake openings 34. Simultaneously with the closure of the containers 4, the robot arm 82 moves the gripping device 1 onward in the direction of the deposition position 87. At this deposition position 87, the underpressure is withdrawn from the first intake openings 21, and the closed containers 4 are set down. The manipulator unit 81 thus closes the containers 4 without a loss of time during the transportation of the containers 4 from the furnishing position 86 to the deposition position 87.

The containers 4 are filled with a pharmaceutical substance directly in the furnishing position 86. Immediately after the completion of the filling process, the gripping device 1 picks up the containers 4 and begins the closing operation right away. As a result of this very fast closure, contamination of the pharmaceutical substance, or its reaction with the surrounding atmosphere, is averted.

Alternatively to picking up the rubber stoppers 5 by means of a towing motion, the pickup of the rubber stoppers 5 can also be intermittent. That is, the gripping device 1 remains stopped at the towing position 83, picks up the rubber stoppers 5, and then moves onward in the direction of the furnishing position 86.

It is also contemplated according to the invention that the pharmaceutical system 8 or manipulator unit 81 be operated inside an insulator 88. To that end, the materials comprising the pharmaceutical system 8, the manipulator unit 81, and the gripping device 1 are selected to suit the requirements for use in the insulator 88.

1-12. (canceled)

13. A gripping device, comprising:
a container pickup device and a closure pickup device for picking up and closing containers, the container pickup device being embodied for picking up a container, and the closure pickup device being embodied for picking up a closure; and
a connection element connecting the closure pickup device to the container pickup device, the connection element enabling a relative motion between the container pickup device and closure pickup device, in order to close the container with the closure.

14. The gripping device as defined by claim 13, wherein the connection element includes a guide element which guides the relative motion between the container pickup device and closure pickup device.

15. The gripping device as defined by claim 14, wherein the guide element is a linear guide element.

16. The gripping device as defined by claim 13, wherein the closure pickup device includes a closure towaway device which is embodied for towing a closure away from a towing position, and the closure towaway device is in constant motion while towing.

17. The gripping device as defined by claim 14, wherein the closure pickup device includes a closure towaway device which is embodied for towing a closure away from a towing position, and the closure towaway device is in constant motion while towing.

18. The gripping device as defined by claim 15, wherein the closure pickup device includes a closure towaway device which is embodied for towing a closure away from a towing position, and the closure towaway device is in constant motion while towing.

19. The gripping device as defined by claim 16, wherein the closure towaway device includes a plate with a curved pocket, and dimensions of the curved pocket correspond to dimensions of the closure.

20. The gripping device as defined by claim 17, wherein the closure towaway device includes a plate with a curved pocket, and dimensions of the curved pocket correspond to dimensions of the closure.

21. The gripping device as defined by claim 18, wherein the closure towaway device includes a plate with a curved pocket, and dimensions of the curved pocket correspond to dimensions of the closure.

22. The gripping device as defined by claim 13, wherein the container pickup device includes a first intake opening which can be subjected to underpressure, and/or the closure pickup device includes a second intake opening which can be subjected to underpressure, in order to hold the container and the closure, respectively.

23. The gripping device as defined by claim 21, wherein the container pickup device includes a first intake opening which can be subjected to underpressure, and/or the closure pickup device includes a second intake opening which can be subjected to underpressure, in order to hold the container and the closure, respectively.

24. The gripping device as defined by claim 22, wherein the first intake opening and the second intake opening have two separate lines, which each communicate, independently of one another, with an underpressure source.

25. The gripping device as defined by claim 23, wherein the first intake opening and the second intake opening have two separate lines, which each communicate, independently of one another, with an underpressure source.

26. The gripping device as defined by claim 13, wherein the closure pickup device can be lowered, in particular being operated pneumatically, in order to close the container with the closure.

27. The gripping device as defined by claim 25, wherein the closure pickup device can be lowered, in particular being operated pneumatically, in order to close the container with the closure.

28. The gripping device as defined by claim 13, wherein the container pickup device is embodied for picking up at least two containers, and the closure pickup device is embodied for picking up at least two closures.

29. The gripping device as defined by claim 27, wherein the container pickup device is embodied for picking up at least two containers, and the closure pickup device is embodied for picking up at least two closures.

30. The gripping device as defined by claim 13, wherein the container pickup device has a contour, corresponding to the container to be picked up, which enables the container to be picked up in form-locking fashion.

31. The gripping device as defined by claim 13, wherein the closure is a stopper.

32. A manipulator unit for picking up and closing containers, wherein the manipulator unit includes at least one gripping device as defined by claim 13.
